(19) United States
(12) Patent Application Publication
(10) Pub. No.: US 2016/0299749 A1
(43) Pub. Date: Oct. 13, 2016

(54) SYSTEM AND METHOD FOR REMOTE INSTALLATION OF SOFTWARE

(71) Applicant: ILANTUS TECHNOLOGIES PVT. LTD., Bangalore (IN)

(72) Inventors: SAURAV SHARMA, Bangalore (IN); PRAMOD BHASKAR, Bangalore (IN)

(21) Appl. No.: 15/096,779

(22) Filed: Apr. 12, 2016

(30) Foreign Application Priority Data
Apr. 13, 2015 (IN) 716/CHE/2015

(51) Int. Cl. G06F 9/445; H04L 29/08; H04L 12/24; H04L 29/06

(52) U.S. Cl. CPC G06F 8/61; H04L 67/42; H04L 67/34; H04L 41/22; H04L 41/046

(57) ABSTRACT

The embodiments herein provide a method and system for a remote installation of software on a remote device. The system includes a server agent, a server, a client device, a client agent, a communication network, an active directory. The server agent pushes a software to a client device from a server, the software received by the client agent is passed on to the client device. The information about the client device is provided by the active directory. The status of the software installation is displayed on the user interface of the server. The server agent and the client agent communicates with each other using a communication network.

### CROSS-REFERENCE TO RELATED APPLICATION

Benefit is claimed under 35 U.S.C. 119(a)-(d) to Foreign application Serial No. 716/CHE/2015 filed in India entitled “A SYSTEM AND METHOD FOR REMOTE INSTALLATION OF SOFTWARE”, on Apr. 13, 2015, which is herein incorporated in its entirety by reference for all purposes.

### BACKGROUND

1. Technical Field

The embodiments herein are generally related to software engineering. The embodiments herein are particularly related to software installation. The embodiments herein are more particularly related to a system and method for remote installation of software on the plurality of computing devices.

2. Description of the Related Art

Software installation refers to a process of setting up a software module for execution in a computing device such as a computer. Software installation typically involves storing the software instructions or the data in appropriate storage locations of a computing device and performing other such configurations required to make the instructions and the data ready for execution.

Software installation is performed either locally or remotely. Remote installation of the software is particularly useful, when the software module has to be installed on multiple devices which are termed as remote devices. The software installation on the remote device is performed using a communication network which connects the installer system and the remote device.

However, the software installation on the remote devices has one or more challenges. One of the challenges includes defining a policy for remote installation and which is time consuming. The other challenges include a lack of control and realization of a number of software installations on the remote devices, a requirement to reboot or restart the computing device during an installation and a lack of reporting and auditing feature on the computing device installed with the software remotely.

One of the conventional techniques to install the software on the remote devices is to install a software using Microsoft® domain Group Policy Object (GPO). According to this method, the software installation is provided by an out of the box domain's Group Policy Object (GPO) for remote devices. With the given application, the installer is able to install the one or more software in Microsoft Installer (MSI) format. The software installation using this approach is based on the device type and the device version. However, this technique is undesirable as the method does not have the reporting capabilities. Therefore, it is difficult to determine a status of the installation on the remote devices. Further, the software installation is not synchronous. Hence the remote device has to wait for its turn until the new GPO policy is refreshed on that device. Furthermore, the device requires multiple boots to receive/push the software installation process which is inefficient and time consuming.

Another conventional method used is to render the software installation using a paid remote installation enterprise application. According to this method, vendors such as Microsoft®, and Novell® provide specialized tools and resources for the installation of the software on the remote devices. The tools usually have the capabilities to audit the installation status such as success and failure events. The installation process is controlled from the Graphical User Interface (GUI). However, a monitoring of the installation is necessary while using this technique. Furthermore, an expert in the field is required to manage the software installation on the remote devices thereby increasing a time consumption and costs.

Hence, there is a need for a method and system for a remote installation of the software efficiently and effectively. Still further, there is a need for a system and method for a remote installation of the software by invoking the commands through a local application on the remote device.

The above-mentioned shortcomings, disadvantages and problems are addressed herein and which will be understood by reading and studying the following specification.

### OBJECTS OF THE EMBODIMENTS

The primary object of the embodiments herein is to develop a system and method for a remote installation of the software on a plurality of the remote computing devices.

Another object of the embodiments herein is to monitor a remote installation of the software with minimum resources.

Yet another object of the embodiments herein is to audit the status of the software installation on the remote device.

Yet another object of the embodiments herein is to provide a method for a scheduled installation of the software on the plurality of the remote devices automatically and remotely.

Yet another object of the embodiments herein is to provide an interface to inform an administrator about the success or failure condition of the software installation on the User Interface (UI).

These and other objects and advantages of the embodiments herein will become readily apparent from the following detailed description taken in conjunction with the accompanying drawings.

### SUMMARY

The various embodiments herein provide a method and system for a software installation on a remote device. The system comprises a server of a service provider comprising a server agent, a remote device comprising a client agent, an active server comprising an active directory, and a communication network.

According to an embodiment herein, the server agent is configured to push a software to a client device from the server. The server agent pushes the software at a scheduled time, and the scheduled time is set by an administrator of the server. According to an embodiment herein, the software installed on the client device based on the configuration of the client device.

The client agent is configured to install the software on a client device, and the client agent is installed on the client device. The client agent receives a notification from the server agent prior to the software installation.

The active directory is configured to provide a plurality of information of the client device to the server, and the active directory resides on the active server device. According to an embodiment herein, the active directory provides a plurality of information of the domain joined client device to the server.

The system includes the communication network that is configured to establish a communication between the client agent and the server agent for the installation of the software remotely.

According to an embodiment herein, the information provided by the active directory include a device type, an operating system of the client device, a version of the operating system, and the number of bits of the operating system.

According to an embodiment herein, the client agent reports a status of the software installation. The status include successful installation, failure of installation, reason for failure of the installation, and the client agent reports the status of the software installation through a User Interface (UI).

According to an embodiment herein, the remote installation of the software on the client device is executed based on an Inter Process Communication (IPC). The Inter Process Communication is responsible for the client device to interact with the server agent to enable software installation.

According to an embodiment herein, the system further includes a memory module configured to store the installation information of the client device. The memory module is communicably coupled with the server agent, and the installation information include date of installation of the software, time of installation of the software, next scheduled update, and expiry date of the remotely installed software.

According to an embodiment herein, the client device is selected from a group consisting of a desktop computer, a laptop computer, a tablet computer, and a device that has an active directory domain joined and capable of communicating with the communication network.

According to an embodiment herein, the remote installation of the software on the client device is enabled along with a third party service provider.

According to an embodiment herein, the remote installation of the software on the client device is enabled as an independent service.

A computer implemented method is provided for remote installation of a software on a client device. The method includes pushing a software to a client device, providing a plurality of information of the client device, establishing a communication between the client agent and the server agent, and installing the software on the client device.

According to an embodiment herein, the software is pushed to the client device at a scheduled time, and the scheduled time is set by an administrator of the server. The software installed on the client device based on the configuration of the client device.

According to an embodiment herein, the information of the client device is provided to the server agent through an active directory

According to an embodiment herein, the client agent and the server agent through a communication network for the installation of the software remotely.

According to an embodiment herein, the software is installed based on the instructions provided by the client agent, and wherein the client agent receives a notification from the server agent prior to the software installation.

According to an embodiment herein, the information provided by the active directory include a device type, an operating system of the client device, a version of the operating system, and the number of bits of the operating system.

According to an embodiment herein, the method further includes reporting a status of the software installation. The status include success report of the installation, failure report of the installation, reason for failure of the installation, and wherein reporting the status is via a user interface (UI) present in the server.

According to an embodiment herein, the software installing process on the client device is executed based on an Inter Process Communication (IPC), and the Inter Process Communication is responsible for the client device to interact with the server agent to enable software installation.

According to an embodiment herein, the software installation information on the client device is stored on a memory module, and the memory module is communicably coupled with the server agent. The installation information include a date of installation of the software, a time of installation of the software, next scheduled update, and the expiry date of the remotely installed software.

According to an embodiment herein, the client device is selected from a group consisting of a desktop computer, a laptop computer, a tablet computer, a mobile phone, a smart phone, a Personal Device Assistants (PDAs), a gaming consoles, a wearable devices, and a device which is active directory domain joined and capable of communicating with the communication network.

According to an embodiment herein, the installation of the software on the client device is enabled with a third party service provider.

According to an embodiment herein, the installation of the software on the client device is enabled as an independent process.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for a software installation on a remote device, according to one embodiment herein.

FIG. 2 illustrates a flowchart explaining a method for the software installation on the remote device, according to one embodiment herein.

Although the specific features of the embodiments herein are shown in some drawings and not in others. This is done for convenience only as each feature may be combined with any or all of the other features in accordance with the present invention.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method and system for a software installation on a remote device. The system comprises a server comprising a server agent, a remote device comprising a client agent, an active server comprising an active directory, and a communication network.

According to an embodiment herein, the server agent is configured to push a software to a client device from the server. The server agent pushes the software at a scheduled time, and the scheduled time is set by an administrator of the server. According to an embodiment herein, the software installed on the client device based on the configuration of the client device.

The client agent is configured to install the software on a client device, and the client agent is installed on the client device. The client agent receives a notification from the server agent prior to the software installation.

The active directory is configured to provide a plurality of information of the client device to the server, and the active directory resides on the active server device. According to an embodiment herein, the active directory provides a plurality of information of the client device to the server.

The system includes the communication network that is configured to establish a communication between the client agent and the server agent for the installation of the software remotely.

According to an embodiment herein, the information provided by the active directory include a device type, an operating system of the client device, a version of the operating system, and the number of bits of the operating system.

According to an embodiment herein, the client agent reports a status of the software installation. The status include successful installation, failure of installation, reason for failure of the installation, and the client agent reports the status of the software installation through a User Interface (UI).

According to an embodiment herein, the remote installation of the software on the client device is executed based on an Inter Process Communication (IPC). The Inter Process Communication is responsible for the client device to interact with the server agent to enable software installation.

According to an embodiment herein, the system further includes a memory module configured to store the installation information of the client device. The memory module is communicably coupled with the server agent, and the installation information include date of installation of the software, time of installation of the software, next scheduled update, and expiry date of the remotely installed software.

According to an embodiment herein, the client device is selected from a group consisting of a desktop computer, a laptop computer, a tablet computer, and a device which is active directory domain joined and capable of communicating with the communication network.

According to an embodiment herein, the remote installation of the software on the client device is enabled along with a third party service provider.

According to an embodiment herein, the remote installation of the software on the client device is enabled as an independent service.

A computer implemented method is provided for remote installation of a software on a client device. The method includes pushing a software to a client device, providing a plurality of information of the client device, establishing a communication between the client agent and the server agent, and installing the software on the client device.

According to an embodiment herein, the software is pushed to the client device at a scheduled time, and the scheduled time is set by an administrator of the server. The software installed on the client device based on the configuration of the client device.

According to an embodiment herein, the information of the client device is provided to the server by an active directory, and the active directory resides on the server.

According to an embodiment herein, the client agent and the server agent through a communication network for the installation of the software remotely.

According to an embodiment herein, the software is installed based on the instructions provided by the client agent, and wherein the client agent receives a notification from the server agent prior to the software installation.

According to an embodiment herein, the information provided by the active directory include a device type, an operating system of the client device, a version of the operating system, and the number of bits of the operating system.

According to an embodiment herein, the method further includes reporting a status of the software installation. The status include success report of the installation, failure report of the installation, reason for failure of the installation, and wherein reporting the status is via a user interface (UI) present in the server.

According to an embodiment herein, the software installing process on the client device is executed based on an Inter Process Communication (IPC), and the Inter Process Communication is responsible for the client device to interact with the server agent to enable software installation.

According to an embodiment herein, the installation information of the client device is stored on a memory module, and the memory module is communicably coupled with the server agent. The installation information include a date of installation of the software, a time of installation of the software, next scheduled update, and the expiry date of the remotely installed software.

According to an embodiment herein, the client device is selected from a group consisting of a desktop computer, a laptop computer, a tablet computer, and a device which is capable of communicating with the communication network.

According to an embodiment herein, the installation of the software on the client device is enabled with a third party service provider.

According to an embodiment herein, the installation of the software on the client device is enabled as an independent process.

The various embodiments herein provide a method and system for a software installation on a remote device. According to an embodiment herein, an administrator initiates the procedure of a software installation on a remote device. According to an embodiment herein, the administrator initiates the process of the software installation automatically using an installer application (a computing device).

According to an embodiment herein, the software installation on the remote devices is executed based on an Inter Process Communication (IPC) thereby making an external application and a light weight agent on the remote device to interact to provide software installation. According to an embodiment herein, the external application notifies the agents on the remote devices to invoke one or more commands on the remote device. Further, the light weight client agent responds with the status messages to the external application on server. According to an embodiment herein, the process of the remote installation of the software is monitored on a User Interface.

According to an embodiment herein, the information about the remote devices is fetched/acquired from the Active Directory server, when the administrator initiates a process of the software installation to the plurality of the remote devices. According to an embodiment herein, the administrator initiates the process of the software installation by click of a button on admin user interface (UI).

According to an embodiment herein, the pre-installed software application on server acquires or collects the information about the plurality of the remote devices for installing the software applications. According to an embodiment herein, an external or a third-party server application acquires or collects the information about the plurality of the remote devices.

According to an embodiment herein, the collected/acquired information include device type, operating system of the device, version of the operating system, number of bits of the operating system, and the like.

According to an embodiment herein, the collected/acquired information about the plurality of the remote devices is passed on to a light weight server agent which in turn pushes the light weight client agent and MSI installer on each remote device. The collected/acquired information about the remote device is passed on to the light weight agent using one or more standard protocols.

According to an embodiment herein, a copy of MSI installer is copied on the remote device. The copy of the MSI installer is installed by the light weight client agent on the remote device.

Furthermore, the remote device reports a success or failure status of the software installation to the administrator through the light weight agent on the remote device via light weight server agent. According to an embodiment herein, the status of the software installation is communicated to the administrator through the communication network, through the process of Inter Process Communication (IPC).

According to an embodiment herein, the light weight client agent executes MSI installer to install MSI. According to an embodiment herein, MSI refers to Microsoft Installer™. According to an embodiment herein, MSI refers to any program that is used for installing and opening the newly installed software applications. According to an embodiment herein, the MSI is installed based on the one or more standard protocols. Furthermore, the installation status reported by light weight client agent on the remote device via light weight server agent to the administrator is displayed on a display console of the administrator.

According to an embodiment herein, the reporting of the success or failure status of the software installation on the plurality of the remote provides an overview of the average success and failure rate of the software installations on the plurality of the remote devices. Further, the system provides a count on the number of software installations that happened remotely. Furthermore, the administrator is enabled to schedule the software installations on the plurality of remote devices based on the needs of the organization.

According to an embodiment herein, the software application for providing the installation of software is pushed on the remote device. According to an embodiment herein, the software application for providing the installation of software is provided as a credential provider. According to an embodiment herein, the software application for providing the installation of the software is provided as Graphical Identification and Authentication (GINA).

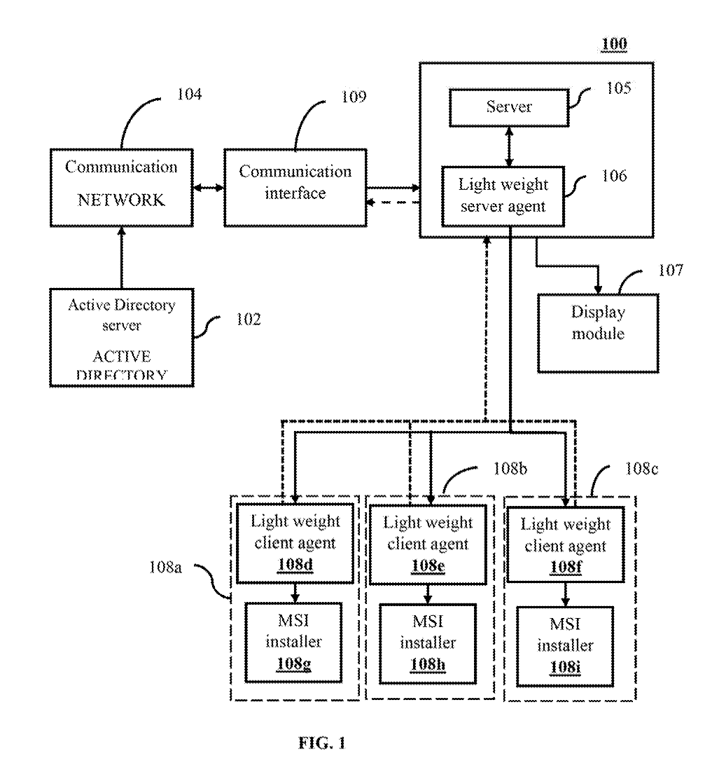

FIG. 1 illustrates a block diagram of a system for software installation on a plurality of remote devices according to an embodiment herein. A light weight client agent is pushed on the remote device through a light weight server agent for receiving the software installation update. FIG. 1 includes an active directory server 102. According to an embodiment herein, the active directory server 102 refers to a server that authenticates and authorizes the end users for accessing one or more software and software applications.

With respect to FIG. 1, the system includes a communication network 104. According to an embodiment herein, the communication network 104 is used for communicating/interacting with the plurality of the remote devices through the light weight server agent. Further, the communication network 104 is used for establishing a communication between the remote devices, the installer, the light weight client agent and the active directory server. According to an embodiment herein, the communication network 104 includes but not limited to Internet, Intranet, Wireless network, Local Area Network (LAN), Wide Area Network (WAN), Metropolitan area network (MAN), and the like. The communication network 104 establishes communication using a communication interface 109. The communication interface 109 coordinates the communication between a plurality of modules including the active directory server 102 and the server module 105.

According to an embodiment herein, the communication network 104 has one or more topologies. According to an embodiment herein, the network topology of the communication network 106 includes but not limited to star network, mesh network, tree network, jellyfish network, bow network, and the like.

With respect to FIG. 1, the system includes a light weight server agent 106 that is pre-installed on the server 105. According to an embodiment herein, the light weight server agent 106 refers to an application that communicates with the installer device and the light weight client agent that is responsible for installing MSI installer. According to an embodiment herein, the light weight server agent 106 communicates with the administrator and the light weight client agent on the remote device to update an installation status of the remote software installation process. According to an embodiment herein, the administrator refers to an account in the installer device that initiates the software installation on plurality of the remote devices.

With respect to FIG. 1, the system includes a hub 108 for remote devices. The hub 108 includes the remote devices 108a, 108b, 108c, on which the software update has to be installed. According to an embodiment herein, each of the remote devices is installed with the light weight client agent. According to an embodiment herein, the light weight client agents are the external software applications downloaded on each remote device. According to an embodiment herein, the remote devices 108a, 108b, 108c are computing devices installed with the light weight client agents 108d, the light weight client agent 108e, and the light weight client agent 108f respectively. The remote device 108a, 108b, and 108c includes the MSI installers 108g, 108h, 108i respectively According to an embodiment herein, the remote devices 108a, 108b, 108c include but are not limited to desktop computer, laptop computer, tablet computer, and a device that is active directory domain joined and the like.

According to an embodiment herein, the remote devices 108a, 108b, 108c receive software installation through the light weight server agent 106. The server agent 106 is communicably coupled with the server 105. According to an embodiment herein, the software installation on the remote devices 108a, 108b, and 108c is initiated by a system administrator using the server 105.

According to an embodiment herein, the light weight server agent 106 initiates the software installation on the remote devices 108a, 108b, 108c through the light weight client agent 108d, the light weight client agent 108e, and the light client agent 108f when a notification is received from the administrator through the communication network 104. Further, the installation status of the software on the remote devices 108a, 108b, and 108c is reported to the administrator and the server through the light weight server agent 106. According to an embodiment herein, the light weight client agent on the remote devices report the status of the remote software installation to the light weight server agent 106.

The system includes a display module 107. The display module 107 displays the status of the remote installation of the software. According to an embodiment herein, the display module is integrated with the existing user interface and does not include a complicated user operation.

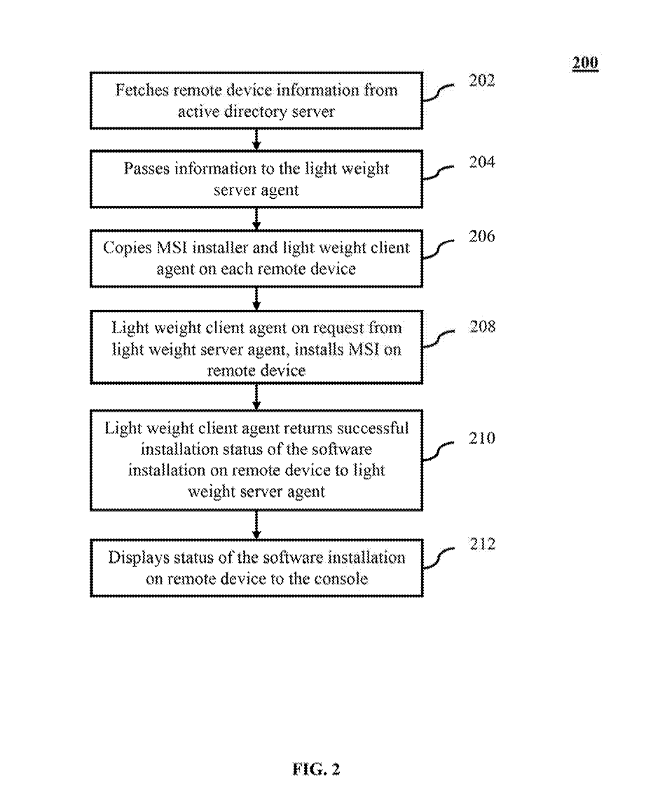

FIG. 2 illustrates a flowchart explaining a method for the software installation on the remote device, according to an embodiment herein. The method comprises initiating the process of the software installation to the plurality of the remote devices with an administrator, and the information about the one or more remote devices is acquired/collected from the active directory server (Step 202). According to an embodiment herein, the pre-installed software application on server for installing the software applications is configured to acquire/collect the information about the plurality of the remote devices. According to an embodiment herein, an external or a third-party application is configured to acquire/collect the information about the plurality of the remote devices. Example of the external or the third-party application that acquires/collects the information about the remote device is the software application (104). According to an embodiment herein, the acquired/collected information includes device type, operating system of the device, version of the operating system, number of bits of the operating system, and the like.

According to an embodiment herein, the acquired/collected information about the plurality of the remote devices is passed on to the light weight server agent that is installed on the server (Step 204). The acquired/collected information about the remote device is passed on to the light weight server agent using one or more standard communication protocols.

According to an embodiment herein, a copy of MSI installer and the light weight client agent is installed on the remote device (Step 206). The copy of the MSI installer is installed by the light weight agent of the remote device.

Furthermore, light weight client agents on the remote devices is configured to install the MSI on the remote devices. According to an embodiment of the present invention, the MSI is installed on the remote device based on the request sent by the light weight server agent. (Step 208). According to an embodiment herein, the installation status of the software installation is communicated to the administrator through the communication network.

Further, the light weight client agent is configured to return the successful installation status of the software installation on the remote device to the light weight server agent (Step 210). According to an embodiment herein, the installation status is transmitted from the light weight client agent to the light weight server agent is via the communication network.

According to an embodiment herein, the installation status of the remote device is displayed on the console of the administrator (Step 212). According to an embodiment herein, the software installation status of a remote device is displayed in the form of Graphical User Interface (GUI).

According to an embodiment herein, the reporting of the success or failure condition of the software installation on the plurality of the remote provides an overview of the average success/failure rate of the software installation. Further, the report provides a count on the number of software installations that happened remotely. Furthermore, the administrator schedules the software installations based on the needs of the organization.

According to an embodiment herein, the software application for providing the installation of software is pushed on the remote device. According to an embodiment herein, the software application for an installation of software is provided as Credential Provider. According to an embodiment herein, the software application for installing the software is provided as Graphical Identification and authentication format (GINA).

The various embodiments herein provide a system for remote installation of a software on a client device. The system includes a server agent, a client agent, a server, and a communication network.

According to an embodiment herein, the server includes a plurality of software that has to be installed on the client device. The server includes a server agent configured to push the software to a client device from the server. According to an embodiment herein, the server agent is a light weight server agent. The server agent pushes the software to the client device at a scheduled time. The scheduled time for pushing the software to the client device is set by the administrator of the server. According to an embodiment herein, the client device determines the schedule for installing the software remotely. The software pushed from the server to the client device is based on the configuration of the client device.

The client agent is responsible for triggering the installation of the software on the client device. According to an embodiment herein, the client device initiates the installation process after receiving a confirmation from the client device. The client agent confirms the software installation after the server agent notifies the client agent. According to an embodiment herein, the server agent notifies the client agent through a push notification in the user interface of the client device. According to an embodiment herein, the server agent notifies the client agent through a command line interface.

The system includes an active directory configured to provide information about the client device to the server. The active directory resides on the client device. The information provided by the active directory include, but are not limited to the device type, operating system, type of operating system, version of operating system, number of bits, last software update, and the like. The active directory provides the information to the server through a client agent which transmits to the server agent through the communication network. According to an embodiment herein, the active directory is present on the client devices having Windows® operating system. According to an embodiment herein, the active directory is present on the client device having any of the available operating systems.

The system further includes a communication network for transmitting information and installation of the software remotely, to and from the client device and the server.

According to an embodiment herein, the server agent transmits the necessary information including the header file, actual software program, and the like to the client device, when the client device accepts a request for remote installation of the software. The client device updates the status of the installation of software to the server device. The status updates include, but are not limited to success of the software installation, failure of the software installation, reason for the failure of the installation, time left for completing the installation, expiry date of the installed software and the like. According to an embodiment herein, the system administrator has the option to include, exclude and modify the other possible status updates that are possible during the remote installation of the software. The status updates are displayed on the user interface of the server.

The remote installation of the software on the client device is executed based on an Inter Process Communication (IPC). The Inter Process Communication is responsible for the client device to interact with the server agent to enable software installation.

The system includes a memory module configured to store the installation information of the client device. The memory module is communicably coupled with the server agent, wherein the installation information include date of installation of the software, time of installation of the software, next scheduled update, and expiry date of the remotely installed software.

According to an embodiment herein, the remote installation of the software on the client device is enabled along with a third-party service. Further, the remote installation of the software is enabled through a single sign-on agent, password recovery agent, and the like.

According to an embodiment herein, the remote installation of the software on the client device is enabled as an independent service.

The various embodiments herein provide a computer implemented method for remote installation of a software on a client device. For enabling the remote installation of the software, at first the software is kept ready to be pushed to the client device through the server agent. The server agent works in conjunction with the server. According to an embodiment herein, the software is pushed to the client device at a scheduled time, and the scheduled time is set by an administrator of the server. According to an embodiment herein, the software installed on the client device based on the configuration of the client device. According to an embodiment herein, when the client device is not compatible for the installation of the software, the installation process is halted either temporarily or permanently.

Further, a plurality of information of the client device is provided to the server through an active directory via the client agent. According to an embodiment herein, the active directory resides on the client device.

A communication channel is established between the client agent and the server agent through the communication network for the installation of the software. After establishing the communication, the installation of the software is initiated and the software is installed on the client device remotely. According to an embodiment herein, the client agent receives a notification from the server through the server agent during the initiation of the software installation.

Further, the method includes reporting a status of the software installation. The reporting of the status include success report, failure report, reason for the failure in the installation, and the like. According to an embodiment herein, the status of the installation is reported via a user interface present in the server.

According to an embodiment herein, the software installing process on the client device is executed based on an Inter Process Communication (IPC), and the Inter Process Communication is responsible for the client device to interact with the server agent to enable software installation.

The method further includes storing the installation data on a memory module. The memory module is communicably coupled with the server agent. According to an embodiment herein, the installation information include a date of installation of the software, a time of installation of the software, next scheduled update, and the expiry date of the remotely installed software.

According to an embodiment herein, the software is installed remotely through a third-party service. The examples of the third-party service include single sign-on agent, password recovery agent, and the like.

According to an embodiment herein, installing the software on the client device is enabled as an independent process.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

The embodiments herein provides a control to the system administrator for the process of software installations on the remote devices. The system and method are configured to provide a reporting feature of the software installation. The system and method provides an enhanced and easy user interface for the software installation on the remote devices. The system and method eliminates a necessity of the multiple time device reboot after the software installation. The system and method provides an analytics of the software installation on the remote devices.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A system for remote installation of software on a client device, the system comprising:
a server comprising a server agent configured to push a software to a client device from a service provider, wherein the server agent pushes the software at a scheduled time, and wherein the scheduled time is set by an administrator of the server, and wherein the software installed on the client device based on the configuration of the client device;
a client agent configured to install the software on a client device, and wherein the client agent is installed on the client device, and wherein the client agent receives a notification from the server agent prior to the software installation;
an active directory server comprising an active directory configured to provide a plurality of information of the client device to the server, and wherein the active directory is configured to provide a plurality of information of the client device to the server through the client agent; and
a communication network configured to establish communication between the client agent and the server agent for the installation of the software remotely.

2. The system according to claim 1, wherein the information provided by the active directory include a device type, an operating system of the client device, a version of the operating system, and the number of bits of the operating system.

3. The system according to claim 1, wherein the client agent is configured to report a status of the software installation, and wherein the status include successful installation, failure of installation, reason for failure of the installation, and wherein the client agent reports the status of the software installation through a User Interface (UI).

4. The system according to claim 1, wherein the software is installed remotely on the client device based on an Inter Process Communication (IPC), and wherein the Inter Process Communication is responsible for the client device to interact with the server agent to enable software installation.

5. The system according to claim 1, further includes a memory module configured to store the installation information of the client device, and wherein the memory module is communicably coupled with the server agent, and wherein the installation information include date of installation of the software, time of installation of the software, next scheduled update, and expiry date of the remotely installed software.

6. The system according to claim 1, wherein the client device is selected from a group consisting of a desktop computer, a laptop computer, a tablet computer and a device that is active directory domain joined and capable of communicating with the communication network.

7. The system according to claim 1, wherein the software is remotely installed on the client device with a third-party service provider.

8. The system according to claim 1, wherein the software is remotely installed on the client device as a stand-alone service.

9. A computer implemented method comprising instructions stored on a non-transitory computer readable storage medium and executed on a computing device comprising a hardware processor and a memory for remote installation of a software on a client device, the method comprises:
pushing a software to the client device through a server agent from a server, wherein the software is pushed to the client device at a scheduled time, and wherein the scheduled time is set by an administrator of the server, and wherein the software installed on the client device based on the configuration of the client device;
providing a plurality of information of the client device to the server through an active directory, wherein the active directory resides on the server side;
establishing a communication between the client agent and the server agent through a communication network for the installation of the software remotely; and
installing the software on the client device, wherein the software is installed based on the instructions provided by the client agent, and wherein the client agent receives a notification from the server agent prior to the software installation.

10. The method according to claim 9, wherein information provided by the active directory include a device type, an operating system of the client device, a version of the operating system, and the number of bits of the operating system.

11. The method according to claim 9 further comprises reporting a status of the software installation, and wherein the status include a success report of the installation, a failure report of the installation, a reason for failure of the installation, and wherein the status is reported through a user interface (UI) present in the server.

12. The method according to claim 9, wherein the software is installed on the client device based on an Inter Process Communication (IPC), and wherein the Inter Process Communication is responsible for the client device to interact with the server agent to enable software installation.

13. The method according to claim 9, wherein the installation information of the client device is stored on a memory module, and wherein the memory module is communicably coupled with the server agent, and wherein the installation information include a date of installation of the software, a time of installation of the software, next scheduled update, and the expiry date of the remotely installed software.

14. The method according to claim 9, wherein the client device is selected from a group consisting of a desktop computer, a laptop computer, a tablet computer, and a device that is active directory domain joined and capable of communicating with the communication network.

15. The method according to claim 9, wherein of the software is installed on the client device by a third-party service provider.

16. The method according to claim 9, wherein the software is installed on the client device as a stand-alone process.
